(19) United States
(12) Patent Application Publication
(10) Pub. No.: US 2013/0229013 A1
(43) Pub. Date: Sep. 5, 2013

(54) ALIGNMENT OF A WAVE ENERGY CONVERTER FOR THE CONVERSION OF ENERGY FROM THE WAVE MOTION OF A FLUID INTO ANOTHER FORM OF ENERGY

(71) Applicants: Nik Scharmann, Bietigheim - Bissingen (DE); Benjamin Hagemann, Gerlingen (DE); Daniel Thull, Stuttgart (DE); Michael Hilsch, Stuttgart (DE)

(72) Inventors: Nik Scharmann, Bietigheim - Bissingen (DE); Benjamin Hagemann, Gerlingen (DE); Daniel Thull, Stuttgart (DE); Michael Hilsch, Stuttgart (DE)

(73) Assignee: Robert Bosch GmbH, Stuttgart (DE)

(21) Appl. No.: 13/599,820

(22) Filed: Aug. 30, 2012

(30) Foreign Application Priority Data
Sep. 3, 2011 (DE) 10 2011 112 483.0

(51) Int. Cl. F03B 13/10

(52) U.S. Cl. CPC F03B 13/10
USPC 290/53

(57) ABSTRACT

A wave energy converter for the conversion of energy from the wave motion of a fluid into another form of energy includes a housing upon which at least one rotor is arranged to rotate in an essentially horizontal axis of rotation. The wave energy converter further includes at least one energy converter connected to the minimum of one rotor, at least two floats arranged on the housing at a distance from each other in a perpendicular direction to the axis of rotation, and a control device which is configured, by the corresponding control of the minimum of two floats, to generate a torque which acts on the housing.

This application claims priority under 35 U.S.C. §119 to patent application no. DE 10 2011 112 483.0, filed on Sep. 3, 2011 in Germany, the disclosure of which is incorporated herein by reference in its entirety.

### BACKGROUND

The present disclosure relates to a wave energy converter for the conversion of energy from the wave motion of a fluid into another form of energy, and to a method for the alignment of such a device.

Various devices for the conversion of energy from the wave motion of water into a usable form of energy, for installation either offshore or onshore, are known from the prior art. An overview of wave energy power plants is included e.g. in “Renewable Energy”, G. Boyle, 2^{nd} Edition, Oxford University Press, Oxford 2004.

Amongst other elements, differences include the manner in which energy is extracted from the wave motion. For example, buoys or floats which lie on the surface of the water are known, the rise and fall of which drives e.g. a linear generator. In another mechanical design, the “Wave Roller”, a two-dimensional resistance element is arranged on the seabed and is tipped back and forth by the motion of the waves. The kinetic energy of the resistance element is converted e.g. into electrical energy by a generator. However, in oscillating systems of this type, the maximum achievable damping/load factor only is 0.5, such that the efficiency of these systems is not generally satisfactory.

In the context of the present disclosure, wave energy converters which are essentially arranged below the surface of the water and in which a crankshaft or rotor shaft is set in rotary motion by the movement of the waves are of specific interest.

In this connection, a system design is known from the publication by Pinkster et al., “A rotating wing for the generation of energy from waves”, 22^{nd} International Workshop on Water Waves and Floating Bodies (IWWWFB), Plitvice, 2007, in which the buoyancy of a resistance runner which is exposed to the wave flux, that is to say of a coupling component which generates hydrodynamic lift, is converted into rotary motion.

US 2010/0150716 A1 also discloses a system comprised of a number of fast-running rotors with resistance runners, in which the rotor cycle is shorter than the wave cycle, and in which a separate profile adjustment is applied. By the appropriate adjustment of the resistance runners, which is not described in greater detail however, the resultant forces generated on the system are available for use in different applications. A disadvantage of the system disclosed in US 2010/0150716 A1 is the use of fast-running rotors of the Voith-Schneider type, which are associated with substantial expenditure for the adjustment of the resistance runners. These require continuous adjustment, within a considerable angular range, in order to accommodate the prevailing flow conditions affecting the resistance runner concerned. In addition, for the equalization of the forces applied to the individual rotors associated with the rotor torque and generator torque, a number of rotors need to be arranged in succession at specific intervals. Bracing arrangements for absorbing generator torque are not described.

In wave energy converters of this generic type, a torque associated with an orbital wave flow is captured and used for the generation of energy, e.g. by means of an electric generator. This energy conversion, together with any other fluid flows which may be superimposed on the orbital flow, will result in the application of torque to the housing of the wave energy converter, such that the latter, in the absence of appropriate bracing, may begin to rotate. DE 10 2011 105 169, which was unpublished at the priority date of the present application, describes a frame with damping plates as a stabilizing arrangement. Any tipping of the frame is countered by a combination of mooring and at least one float. A similar form of torque compensation is described in DE 10 2010 054 795 A1.

It is desirable that a simple method should be available for the achievement of the desired alignment of a wave energy converter.

### SUMMARY

The disclosure proposes a wave energy converter, and a method for the alignment thereof. Advantageous embodiments are described in the subclaims, and in the following description.

A datum point for the rotor is provided in the form of a housing, to which the former is secured in a rotational arrangement. In wave energy converters of this generic type, it is necessary for the housing to be braced against the application of torque, in order to prevent any unwanted rotation and/or displacement of the housing. Under the terms of the disclosure, the housing is provided with a minimum of two floats for this purpose, which are arranged at a distance from each other in a directional projection, perpendicular to the axis of rotation. These floats are also arranged at a distance from the axis of rotation itself, thereby allowing the generation of an appropriate counter-torque which will prevent any unwanted rotation and/or displacement of the housing. To this end, the effective flotation volume in at least one of the minimum of two floats is adjustable. For the purposes of torque bracing, an appropriate mooring system for the anchoring of the machine is not required, or only required to a limited extent. The disclosure is provided with a control device (using an open or closed control circuit) for the setting of the counter-torque.

In a preferred embodiment, the control device is also configured for the control of the depth of immersion, in addition to the control of inclination. A preferred embodiment, in which the effective flotation volume in the minimum of two floats is adjustable, permits the particularly advantageous generation of the desired hydrostatic lift, thereby allowing the depth of immersion of the wave energy converter to be adjusted. Small adjustments to this lift allow the fine control of the depth of immersion, e.g. as a means of protecting the machine against the excessively high levels of energy associated with heavy swells, should the machine be displaced into deep waters, or for the conveyance of the latter to the surface for performing maintenance operations.

In principle, inclination can be controlled by the difference between the effective flotation volumes, while the depth of immersion can be controlled by the sum of the effective flotation volumes.

A core element of the disclosure is the use of multiple floats which, by means of an actively adjustable (e.g. pump-operated) fluid delivery system (e.g. for air or water), allow a variable torque to be applied to the installation. Accordingly, the angle of inclination of the installation required for the application of a given torque to the latter may be maintained at a desired fixed value, preferably zero. A further advantage is provided in that the depth of immersion of the installation can be adjusted by means of the fullness of the floats.

The floats used may be configured with solid walls and permanent cavities, into which greater or smaller volumes of the flotation fluid (preferably air) may be delivered. Floats of this type may be configured e.g. in the form of tanks, vats, canisters, etc. They may also be constructed in a form which is open to the sea.

The floats used may also be of the flexible type, provided with adjustable cavities into which greater or smaller volumes of the flotation fluid (preferably air) may be delivered. Floats of this type may be configured e.g. in the form of balloons, lifting bags, etc.

It is appropriate that, insofar as possible, the flotation fluid should be recyclable, e.g. available for mutual conveyance between the floats and/or for conveyance to and from a storage unit (specifically by means of a pump). Alternatively, air may also be discharged into the sea.

The wave energy converter will preferably be provided with a generator, for the purposes of energy conversion. Specifically, this may be a generator of the direct-drive type, in order to minimize any drive train losses. As an alternative, however, the interposition of a gear mechanism is also possible. The generation of pressure in an appropriate medium by means of a pump also is possible. Although this pressure, in itself, constitutes a useful form of energy, it can be (re-)converted into a torque by means of a hydraulic motor and fed into a generator.

A rotor provided with a double-sided rotor base in relation to its plane of rotation, such that at least one coupling element is fitted to either side of the said rotor base, can also be advantageously used. By this arrangement, the conversion of forces acting on a generator-rotor combination into useful energy can be specifically increased and, by the targeted control of the effective torque on either side of the double-sided rotor base, as described specifically in DE 10 2011 105 178, the position of a corresponding wave energy converter can be selectively controlled. Where the forces acting on either side of the double-sided rotor are different, a torque which acts in a perpendicular axis to the axis of rotation of the double-sided rotor may be generated on the rotor, thereby resulting in the rotation of the wave energy converter in a perpendicular axis to the axis of rotation of the rotor. This permits an exceptionally accurate alignment, e.g. to the direction of wave propagation. To this end, not all the coupling elements necessarily need to be configured as adjustable—the adjustability of a proportion of the coupling elements will suffice.

For fitting to the rotor, coupling elements of the resistance runner type are specifically preferred which, in response to a current flow, not only generate a resistance force in the direction of the local current flow itself, but specifically generate a buoyant force which is essentially perpendicular to the current flow. Although these may be e.g. resistance runners with profiles in accordance with the NACA Standard (National Advisory Committee for Aeronautics), the disclosure is not restricted to profiles of this type. The use of Eppler profiles is specifically preferred. In a rotor of this type, the local current flow, and the associated flow angle, are determined by the superimposition of the orbital flow in the local or instantaneous wave flux direction, the tangential velocity of the resistance runner on the rotor and the setting angle of the resistance runner. Accordingly, by the specific adjustment of the minimum of one resistance runner, the orientation of the resistance runner can be optimized in relation to the prevailing local flow conditions. The use of flaps, of a similar type to those fitted to aircraft wings, and/or the adjustment of the lift profile geometry (or “morphing”) is also possible as a means of influencing flow conditions. The adjustments indicated are included in the scope of “modifications of form”.

Further advantages and features of the disclosure are presented in the description and the attached diagram.

It is understood that the abovementioned characteristics, together with the characteristics described below, are not only applicable in the combination indicated, but also in other combinations or in isolation, whilst remaining within the scope of the present disclosure.

The disclosure is schematically represented by the examples of execution shown in the diagrams, and is described in detail below with reference to the diagrams.

### BRIEF DESCRIPTION OF THE DRAWINGS

FIG. 1 shows a side view of a wave energy converter comprising a rotor with two resistance runners, and represents the setting angle γ and the phase angle Δ between the rotor and the orbital flow.

FIG. 2 shows an inclined wave energy converter with equally-filled floats.

FIG. 3 shows a non-inclined wave energy converter with unequally-filled floats.

FIG. 4 shows a preferred control circuit layout for a wave energy converter, for the control of inclination and lift.

FIG. 5 shows a perspective view of a further wave energy converter with a rotor for the conversion of energy from wave motion and a double-sided arrangement of coupling elements.

FIG. 6 shows a perspective view of a wave energy converter with a rotor for the conversion of energy from wave motion and a double-sided arrangement of coupling elements, fitted to a support structure.

FIG. 7 shows a perspective view of a number of wave energy converters with rotors for the conversion of energy from wave motion, fitted to a support structure.

FIG. 8 shows a perspective view of a number of wave energy converters with rotors for the conversion of energy from wave motion, fitted to a support structure, with a double-sided arrangement of coupling elements.

FIG. 9 shows a perspective view of a number of wave energy converters with rotors for the conversion of energy from wave motion, fitted to a support structure and provided with a partial double-sided arrangement of coupling elements.

### DETAILED DESCRIPTION

In the figures, equivalent elements or elements exercising the same function are marked with identical reference numbers. In the interests of clarity, any repeated explanation has been omitted.

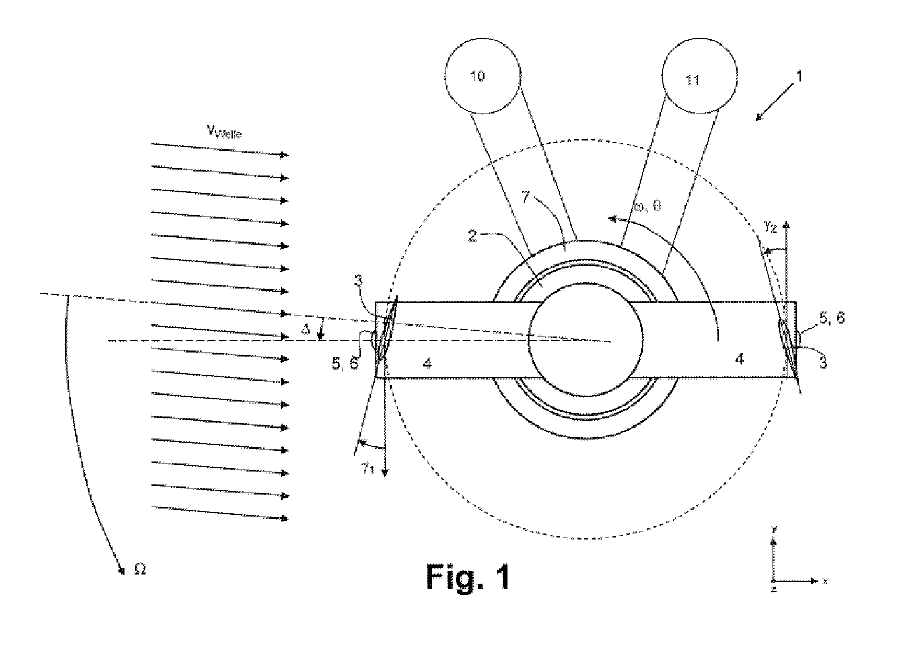

FIG. 1 shows a wave energy converter 1 with a housing 7 and a rotor 2, 3, 4 with a rotor base 2, and two coupling elements 3 attached to the rotor base 2 by means of lever arms 4. The housing 7 is provided with two floats 10, 11, which are arranged at a distance from each other in a direction x, perpendicular to the axis of rotation of the rotor (in this case, running in direction z).

The rotor 2, 3, 4 is arranged below the surface of undulating water—e.g. in an ocean. Its axis of rotation is essentially horizontal and essentially perpendicular to the current direction of wave propagation in the undulating water concerned. In the example represented, the coupling elements 3 are configured as lift profile sections. To this end, deep water conditions are preferred, in which the orbital paths described by water molecules, as indicated, are largely circular. The rotating components of the wave energy converter are preferably configured with largely neutral lift, in order to eliminate the assumption of any preferred position.

The coupling elements 3 are configured as resistance runners and arranged at an angle of 180° to each other. The resistance runners are preferably supported in the vicinity of their action point, in order to reduce rotation moments, which occur during operation, on the resistance runners and thereby to reduce stresses on the support structure and/or the adjusting devices.

The radial clearance between the suspension point of a coupling element and the rotor axis lies within the range of 1 m to 50 m, while a range of 2 m to 40 m is preferred, a range of 4 m to 30 m is specifically preferred, and a range of 5 m to 20 m is especially preferred.

Two adjusting devices 5 are also represented for the adjustment of the setting angles γ₁ and γ₂ of the coupling elements 3, between the blade chord and the tangent to the trajectory. The two setting angles γ₁ and γ₂ are preferably oriented in opposition to each other, and preferably have values within the range of −20° to 20°. However, larger setting angles may be applied, specifically upon the start-up of the machine. The setting angles γ₁ and γ₂ can preferably be independently adjusted. The adjusting devices may be e.g. electric motor-driven adjusting devices—preferably with pulse motors—and/or may be comprised of hydraulic and/or pneumatic components. Each of the two adjusting devices 5 may also be provided with a sensor 6 for the determination of the current setting angles γ₁ and γ₂.

The wave energy converter 1 is exposed to an orbital flow at a flux velocity v_{Wave}. The flux exposure concerned involves the orbital flow of sea waves, the direction of which is continuously changing. In the case represented, the rotation of the orbital flow is oriented in an anti-clockwise direction, with the propagation of the associated waves from right to left.

For further details of the mode of operation of a wave energy converter of this type, reference is made to the abovementioned document DE 10 2011 105 169, the disclosure of which is also included in the present application.

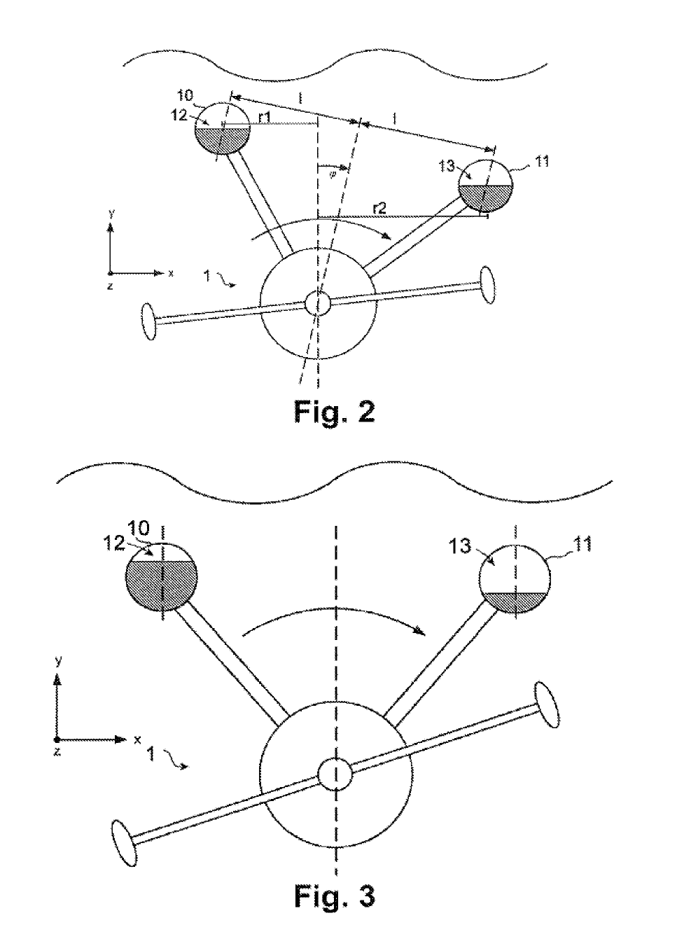

FIG. 2 shows a schematic representation of a wave energy converter (specifically as represented in FIG. 1) in an operating position, whereby the waves are propagated in the water in the x-direction from left to right.

The spacing of the floats 10 and 11 from the center line is the same in both cases, and is represented by 1. The floats 10, 11 represented contain equal effective flotation volumes 12 and, respectively, 13, e.g. volumes of air. By the capture of the forces generated on the coupling elements by the orbital flow, by means of the generator, a load moment M_{load} is applied to the housing 7, which results in the inclination indicated. A state of equilibrium will be reached where this load moment is offset by the counter-torque generated by the likewise inclined floats 10, 11 (resulting from the difference in the respective distances r1 and r2 of the floats from the vertical, associated with axial rotation). This gives an angle of inclination φ.

FIG. 3 indicates how the wave energy converter according to the disclosure can be configured in such a way that the angle of inclination φ=0. To this end, the effective flotation volumes 12, 13 in the floats 10 and, respectively, 11 are adjusted for the generation of a sufficient counter-torque to deliver an angle φ=0. A control device within the wave energy converter 1 fills or drains the floats 10 and 11, in accordance with the present measured angle of inclination. The angle of inclination can be measured by means of a sensor (e.g. in the form of a plumb line) in the housing 7. In the example shown, liquid is pumped from the float 11 into the float 10 (or air from the float 10 into the float 11) until an angle of inclination φ=0 is achieved. The overall buoyant force is not altered as a result.

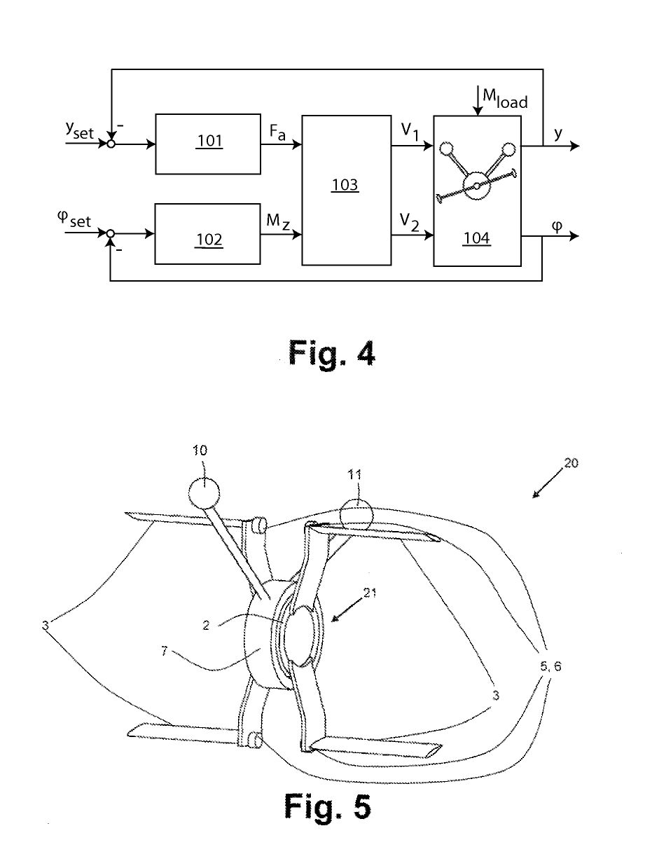

FIG. 4 shows the structure of a control device in a closed control circuit for a wave energy converter 1. The structure is derived, on an exemplary basis, from the embodiment shown in FIGS. 1 to 3 with two floats, e.g. steel tanks. Actual values for the depth of immersion y and the angle of inclination φ respectively are referred to a given reference point, where they are compared with the setpoint values yₛₑₜ and φₛₑₜ. The resulting control deviation in each case is referred to an associated control element 101 or 102. The control variables generated by the control element 101 for the depth of immersion y and by the control element 102 for the angle of inclination φ are a buoyant force Fₐ and a counter-torque M_{z} respectively. Both setpoint values are referred to a conversion element 103, which determines the setpoint values for the effective flotation volumes V₁ and V₂. These are supplied as actuating variables to the control system 104.

For a small angle of inclination φ, these control variables are approximated as follows:

Fₐ=ρg(V₁+V₂), M_{z}=lρg(V₂−V₁),

where:

ρ is the density of the surrounding fluid (sea water)

V₁, V₂ are the effective flotation volumes (air)

g is acceleration due to gravity

l is the distance between the floats and the center line

These equations allow the straightforward calculation of actuating variable conversion, as follows:

$${V}_{1} = \frac{l {F}_{a} - {M}_{z}}{2 l ρ g} , {V}_{2} = \frac{l {F}_{a} + {M}_{z}}{2 l ρ g}$$

required for the determination of the effective flotation volumes (in this case, the levels of air fullness in the floats) associated with a given buoyant force and a given torque.

For a large angle of inclination φ, the following applies:

M_{z}=ρ*g*(r2*V₂−r1*V₁)

with the corresponding adjustment of actuating variable conversion.

The principle of alignment according to the disclosure may be particularly advantageously associated with various embodiments of a wave energy converter, as described below.

FIG. 5 shows a further embodiment of a wave energy converter 20 with a double-sided rotor. This embodiment is characterized in that coupling elements 3 are arranged on either side of the rotor base 2. The properties and characteristic features described above in the comments on FIGS. 1 to 4 may be applied and transferred to this wave energy converter with a double-sided rotor, whether individually or in combination. The alignment of a wave energy converter of this type, using the floats 10, 11, is particularly straightforward. The inclusion of further floats also allows the control of lateral inclination.

Where the direction of propagation of a monochromatic wave lies perpendicular to the axis of rotation of the rotor, the coupling elements arranged adjacently in pairs are, under ideal circumstances, exposed to absolutely identical flow conditions. In this case, the setting angles y of these adjacently arranged coupling elements can preferably be set to an identical value. If, under actual operating conditions, the two halves of the rotor are subject to different flow conditions, the setting angle of each coupling element 3 can be adjusted individually for the optimum accommodation of the local flow.

The double-sided structure also permits rotation about the y-axis.

Independently of the double-sided structure, this is a preferred embodiment, in which the energy converter is configured as a direct-drive generator 21 which, as an integral element of the wave energy converter 20 and its supports, forms the housing 7 of the wave energy converter, and in which the coupling elements 3 are directly connected to the armatures 2 of the generator 21 which form the rotor base 2 by means of lever arms. A wave energy converter 10 of this characteristic form therefore has a particularly compact structure which, by the omission of a shaft, allows structural costs to be minimized

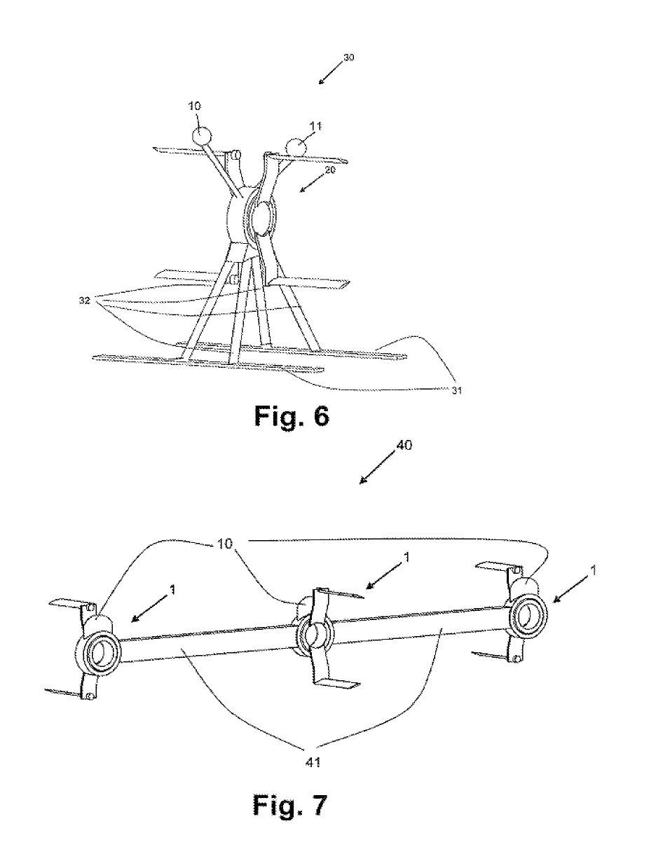

FIG. 6 shows a wave energy converter 30 which includes further elements, in addition to a wave energy converter 20 represented in FIG. 5. Specifically, these elements are damping plates 31 which are connected to the housing 7 or a support structure of a direct-drive generator in an essentially rigid mannet by means of a frame 32. The damping plates 31 lie in greater depths of water than the rotor. In these greater depths of water, the orbital movement of water molecules associated with wave motion is substantially reduced, such that the damping plates 31 exert a supporting and stabilizing effect on the wave energy converter 30.

This type of stabilization provides an advantageous means of retaining the axis of rotation in a stationary position in a first approximation. In the absence of such stabilization, rotor forces would, in extreme cases, result in the orbital movement of the axis of rotation in phase displacement with the orbital flow, thereby resulting in the fundamental alteration of the flow conditions experienced by the coupling elements 3. This would have a consequent negative influence upon the operation of the wave energy converter. It should be understood, however, that a wave energy converter may be stabilized by other means, which do not necessarily include damping plates.

For exemplary purposes, both damping plates are represented in the horizontal position. However, other configurations, in which the damping plates show a different alignment, may also be considered as advantageous. For example, both plates could be inclined at an angle of 45° to the horizontal such that, in combination, they enclose an angle of 90°. Other configurations may be inferred by a person skilled in the art. Damping plates of different geometries and/or in different numbers may also be employed.

Damping plates 31 may also be configured for the adjustment of their angle and/or their damping effect. The damping effect may be influenced e.g. by the adjustment of fluid permeability. Under certain circumstances, a cyclical variation in damping allows the response of the wave energy converter 30 to be influenced in response to the forces applied.

As an alterative to a double-sided rotor, a single-sided rotor may also be used.

FIG. 7 shows a wave energy converter 40 with three (partial) wave energy converters 1, provided with single-sided (partial) rotors in accordance with FIG. 1. In this arrangement, the (partial) wind energy converters, with an essentially parallel axis of rotation, are fitted to an essentially horizontal frame 41, such that the rotors lie below the water surface and their axes of rotation are essentially perpendicular to the incoming wave. In the case represented, the distance between the first and the last rotor is approximately equivalent to the length of the sea wave concerned such that, in the case of the monochromatic wave considered, the front and rear rotor have the same alignment, whereas the central rotor is offset by 180°. All three rotors rotate counter-clockwise, that is to say the wave runs over the machine from the rear. Lengths of sea waves range from 40 m to 360 m, whereby typical waves have a length of from 80 m to 200 m.

The frame 41 and/or the rotors are advantageously provided with a number of floats 10, by means of which the depth of immersion can be regulated and a counter-torque can be generated.

The frame 41 may be executed for the adjustment of the distance between the rotors, such that the length of the machine can be adjusted to the actual wave length. However, machines are also considered which are considerably longer than a single wave length and are provided with a different number of rotors, thereby resulting in a further improvement in the stability of the machine by the superimposition of forces applied.

In addition, in the interests of further stabilization, damping plates may be provided, which may be arranged in a greater depth of water. Similarly for the further stabilization of the installation, specifically to counter rotation about the longitudinal axis, buoyancy systems may also be arranged on a minimum of one cross-arm. A cross-arm of this type, which is preferably essentially horizontal, may be arranged e.g. at the rear end of the frame.

The frame 41 of the wave energy converter can also be executed in the form of a floating frame, and the submersed rotors, arranged below the water surface and with an essentially horizontal rotor axis, can be secured to rotate on the floating frame by means of a corresponding frame structure. A floating frame of this type, depending on its characteristics, delivers an element of torque equalization since the characteristic torque applied and the resulting inclination cause displacement of the immersion volume.

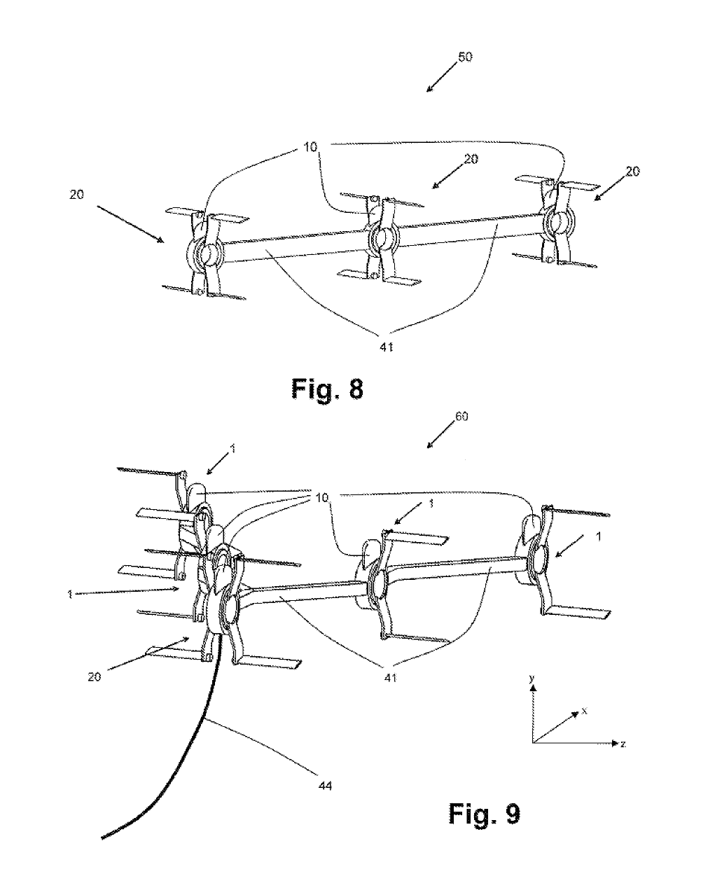

FIG. 8 shows an alternative embodiment of an advantageous wave energy converter 50, with an essentially horizontal frame span and a number of double-sided rotors. In comparison with an arrangement 40 of single-sided rotors, this is a particularly advantageous embodiment since the number of rotors increases the torque input per generator.

FIG. 9 shows a further alternative embodiment of an advantageous wave energy converter 60, comprised of a combination of a single double-sided rotor and a number of single-sided rotors and an essentially horizontal frame span. The frame 61 is configured in a V-shape, in order to prevent and/or minimize any shadowing between the various rotors. As an alternative, double-sided rotors may also be provided here in each case.

An anchor system 44 (mooring) is also represented, preferably secured at the point of the V-shaped arrangement such that, by the influence of weather vane effects, the wave energy converter 30 preferably achieves a substantially independent alignment to the wave, and is therefore exposed to the wave flux from the front. This results in the application of essentially perpendicular flux to the rotor axes, which may be still further optimized e.g. by the control of rotor forces. Similar anchor arrangements may also be provided for the systems represented in the other figures, specifically as a means of ensuring the positional consistency of the installations.

Although the buoyancy systems 10 provided can generate a counter-torque, the incorporation of anchor forces associated with the mooring system 44 is also possible. For the reinforcement of the frame, stays and/or braces may also be provided. Stabilization can also be achieved by the use of damping plates of the type represented in FIG. 6. By variations in the fullness of the floats 10 arranged at intervals in the z-direction, an effective torque can be generated which acts on the frame 41 in the x-direction. The same applies to an individual wave energy converter with floats arranged at intervals in the z-direction, which would then generate a torque on the housing in the x-direction.

What is claimed is:

1. A wave energy converter for the conversion of energy from the wave motion of a fluid into another form of energy, comprising:
a housing upon which at least one rotor is arranged to rotate in an essentially horizontal axis of rotation;
at least one energy converter connected to the at least one rotor;
at least two floats arranged on the housing at a distance from each other in a perpendicular direction to the axis of rotation; and
a control device which is configured, by the corresponding control of the at least two floats, to generate a torque which acts on the housing.

2. The wave energy converter according to claim 1, wherein the control device is configured, by the corresponding control of the at least two floats, to generate a buoyant force which acts on the housing.

3. The wave energy converter according to claim 1, wherein the control operation incorporates the adjustment of an effective flotation volume of at least one of the at least two floats.

4. The wave energy converter according to claim 3, further comprising a pump configured to exchange fluid between the floats.

5. The wave energy converter according to claim 1, wherein at least one of the at least two floats is of rigid construction and has a constant volume.

6. The wave energy converter according to claim 1, wherein at least one of the at least two floats is of elastic construction and has a variable volume.

7. The wave energy converter according to claim 1, wherein the housing is configured with at least three floats, at least two of which are arranged at intervals in a perpendicular direction to the axis of rotation, and at least two of which are arranged at intervals in a parallel direction to the axis of rotation, and wherein the control device is configured, by the corresponding control of the at least two floats arranged at intervals in the parallel direction to the axis of rotation, to generate a second torque which acts on the housing.

8. The wave energy converter according to claim 1, wherein the at least one rotor is configured with at least one coupling element that is configured to generate torgue on the rotor from the wave motion by generating a hydrodynamic buoyant force.

9. The wave energy converter according to claim 8, wherein the control device is configured to set one or more of the magnitude and the direction of the hydrodynamic buoyant force by the adjustment of one or more of a position and a form of the at least one coupling element.

10. The wave energy converter according to claim 8, wherein the at least one coupling element is fitted to at least one rotor base which is arranged at a distance from the axis of rotation of the at least one rotor.

11. The wave energy converter according claim 1, wherein the at least one rotor is configured with a double-sided rotor base in its plane of rotation, and either side of the rotor base is configured with at least one coupling element.

12. The wave energy converter according to claim 11, wherein a mechanism is configured to set the coupling elements independently or set the coupling elements in combination.

13. The wave energy converter according to claim 1, wherein the at least one energy converter is configured as a direct-drive generator, and wherein the at least one rotor is the drive component of the generator.

14. The wave energy converter according to claim 13, wherein the direct-drive generator has an armature that forms a rotor base of the at least one rotor.

15. The wave energy converter according to claim 1, further comprising one or more of at least one stabilizing frame and damping plates configured to stabilize one or more of the wave energy converter and an anchor system configured to anchor the wave energy converter.

16. The wave energy converter according to claim 1, further comprising a number of single-sided rotors and/or double-sided rotors arranged on an elongate structure.

17. A method for the alignment of a wave energy converter, comprising:
adjusting at least one float of a plurality of floats arranged on a housing of the wave energy converter to generate different hydrostatic buoyant forces; and
generating a torque which acts on the housing by the adjustment of the at least one float.

18. The method according to claim 17, wherein a hydrostatic buoyant force which acts on the housing is generated by the adjustment of the floats to generate specific hydrostatic buoyant forces.

19. The wave energy converter according to claim 16, wherein the number of single-sided rotors and/or double-sided rotors are arranged on a V-shaped structure.
